(19) United States
(12) Patent Application Publication
(10) Pub. No.: US 2024/0184646 A1
(43) Pub. Date: Jun. 6, 2024

(54) METHODS AND APPARATUS FOR DISARMING DYNAMIC DATA EXCHANGE IN MS EXCEL

(71) Applicant: SECULETTER CO.,LTD., Gyeonggi-do (KR)

(72) Inventor: Jae Young YI, Hwaseong-si (KR)

(73) Assignee: SECULETTER CO.,LTD., Gyeonggi-do (KR)

(21) Appl. No.: 17/780,860

(22) PCT Filed: May 26, 2022
(86) PCT No.: PCT/KR2022/007493

§ 371 Date: May 27, 2022

(51) Int. Cl. G06F 9/54; G06F 40/103; G06F 40/18

(52) U.S. Cl. CPC G06F 9/543; G06F 40/103; G06F 40/18

(57) ABSTRACT

This specification relates to a method of disarming, by a server, dynamic data exchange (DDE) in a non-portable executable (non-PE) file. The method may include determining a format of the non-PE file, searching the non-PE file for a first file for defining a content type based on the format of the non-PE file being an MS-OOXML SpreadsheetML format, checking whether external link information related to the DDE is present based on the first file, identifying a location of an external link file based on the external link information being present, checking whether a DDE-related element is present in the external link file based on the location of the external link file, and disarming 1) a service name attribute and 2) DDE server topic attribute of the DDE-related element.

### TECHNICAL FIELD

This specification relates to a method and apparatus for disarming a dynamic data exchange (DDE) object in an MS Excel document format.

### BACKGROUND ART

The Office Open XML (Open XML, OOXML) standard is a file format based on XML, and was advanced by Microsoft and approved as European Standards (ECMA-376) and International Standards (ISO/IEC 29500). The standard includes WordprocessML (MS Word documents: .docx, .docm, etc.), PresentationML (PowerPoint documents: .pptx, .pptm, etc.), and SpreadsheetML (Excel document: .xlsx, .xlsm, etc.).

The MS-XLS standard is used in an Excel document (.xls) as a binary-based file format that is stored in the form of a compound file binary (CFB: a format in which several files and folders are stored in one file). A dynamic data exchange (DDE) enables information to be shared in Windows, OS/2, and another operating system or enables information to be communicated between programs. For example, when a form is changed in a database program or a data item is changed in the Spreadsheet program, the DDE may set a form or items which may be simultaneously used by any other program so that the form or items are also changed. The DDE is inter-process communication (IPC), and it uses a shared memory as a common exchange area and may provide an application program with a protocol or an instruction and a message format. The DDE uses a client/server model in which data requested by an application program is considered as a client and data provided by the application program is considered as a server.

A problem in that an XLS or XLSX document is vulnerable to security may occur because the XLS or XLSX document includes a DDE object and executes an external program. If the included DDE object is unconditionally removed from the XLS or XLSX document for disarming, a problem in that the layout of the XLS or XLSX document is warped while the XLS or XLSX document operates in an office document may frequently occur.

### DISCLOSURE

### Technical Problem

Various embodiments are directed to proposing a method of performing the disarming of a DDE object so that the layout of an MS Excel document format is not changed.

Technical objects to be achieved by this specification are not limited to the aforementioned object, and the other objects not described above may be evidently understood from the following detailed description of the specification by a person having ordinary knowledge in the art to which this specification pertains.

### Technical Solution

In an embodiment, a method of disarming, by a server, dynamic data exchange (DDE) in a non-portable executable (non-PE) file may include determining a format of the non-PE file, searching the non-PE file for a first file for defining a content type based on the format of the non-PE file being an MS-OOXML SpreadsheetML format, checking whether external link information related to the DDE is present based on the first file, identifying a location of an external link file based on the external link information being present, checking whether a DDE-related element is present in the external link file based on the location of the external link file, and disarming 1) a service name attribute and 2) DDE server topic attribute of the DDE-related element.

Furthermore, the first file may be a [Content_Types].xml file.

Furthermore, the checking of whether the external link information is present may be based on a content type within an element of the first file.

Furthermore, the external link file may be an externalLink1.xml file.

Furthermore, the service name attribute may be a ddeService attribute, and the DDE server topic attribute may be a ddeTopic attribute.

Furthermore, the method may further include searching for a Workbook stream based on the format of the non-PE file being an XLS format, checking whether a SupBook item is present based on the Workbook stream, searching for a virPath field based on a ctab field of the SupBook item being designated as 0x0000, checking whether the virPath field comprises an execution instruction related to the DDE, and disarming a virPath field comprising the execution instruction.

Furthermore, the disarming of the virPath field may include replacing the virPath field with “_.”

In an embodiment, a server which disarms dynamic data exchange (DDE) in a non-portable executable (non-PE) file may include a communication unit, a memory comprising a contents disarm and reconstruction (CDR) engine for performing the disarming, and a processor configured to functionally control the communication unit and the memory. The processor may be configured to determine a format of the non-PE file, search the non-PE file for a first file for defining a content type based on the format of the non-PE file being an MS-OOXML SpreadsheetML format, check whether external link information related to the DDE is present based on the first file, identify a location of an external link file based on the external link information being present, check whether a DDE-related element is present in the external link file based on the location of the external link file, and disarm 1) a service name attribute and 2) DDE server topic attribute of the DDE-related element.

### Advantageous Effects

According to an embodiment of this specification, the disarming of a DDE object can be performed so that the layout of an MS Excel document format is not changed.

Effects which may be obtained in this specification are not limited to the aforementioned effects, and other effects not described above may be evidently understood by a person having ordinary knowledge in the art to which this specification pertains from the following description.

### BRIEF DESCRIPTION OF DRAWINGS

FIG. 1 is a diagram illustrating a server or a client related to this specification.

FIG. 2 is an example of an abnormal input which may be applied to this specification.

FIG. 3 exemplifies a method of disarming DDE in MS-OOXML SpreadsheetML to which this specification may be applied.

FIG. 4 exemplifies binary codes of SupBook to which this specification may be applied.

FIG. 5 exemplifies a method of disarming DDE in an XLS format to which this specification may be applied.

The accompany drawings, which are included as part of the detailed description in order to help understanding of this specification, provide embodiments of this specification and describe the technical characteristics of this specification along with the detailed description.

### MODE FOR INVENTION

Hereinafter, embodiments disclosed in this specification are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various elements, but the elements are not restricted by the terms. The terms are used to only distinguish one element from the other element.

When it is said that one element is “connected” or “coupled” to another element, it should be understood that one element may be directly connected or coupled to another element, but a third element may exist between the two elements. In contrast, when it is described that one element is “directly connected to” or “brought into direct contact with” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

Furthermore, the term “. . . unit” used in this specification means a software or hardware element, and the “. . . unit” performs specific tasks. However, the term “. . . unit” does not mean that it is limited to software or hardware. The “. . . unit” may be configured to reside on an addressable storage medium and configured to operate one or more processors. Accordingly, examples of the “. . . unit” may include elements, such as software elements, object-oriented software elements, class elements, and task elements, processes, functions, attributes, procedures, sub-routines, segments of a program code, drivers, firmware, a microcode, circuitry, data, a database, data structures, tables, arrays, and variables. The functionalities provided in the elements and the “. . . units” may be combined into fewer elements and “. . . units”, or may be further separated into additional elements and “. . . units”.

Furthermore, “. . . unit” according to an embodiment of this specification may be implemented as a processor and a memory. The term “processor” should be widely interpreted as including a general-purpose processor, a central processing device (CPU), a microprocessor, a digital signal processor (DSP), a controller, a microcontroller, a state machine, etc. In some environments, the “processor” may denote an application-specific semiconductor (ASIC), a programmable logic device (PLD), a field programmable gate array (FPGA), etc. The term “processor” may denote a combination of processing devices, such as a combination of a DSP and a microprocessor, a combination of a plurality of microprocessors, a combination of one or more microprocessors combined with a DSP core, or a combination of any other such elements.

The term “memory” should be widely interpreted as including any electronic component capable of storing electronic information. The term “memory” may denote various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, a magnetic or optical data storage device, and registers. If a processor can read information from memory and/or record information on the memory, the memory is said to be in the state in which the memory electronically communicates with the processor. The memory integrated on the processor may be in the electronic communication state with the processor.

The concept of a “non-portable executable (non-PE)” used in this specification is opposite to the concept of a PE file or an executable file, and the “non-PE file” means a file that is not autonomously executed. For example, the non-PE file may be a document file such as a PDF file, a Hangul file, or a MS Word file, an image file such as a JPG file, a video file, a JavaScript file, or an HTML file, but the present disclosure is not limited thereto.

Hereinafter, embodiments are described in detail with reference to the accompanying drawings in order for a person having ordinary knowledge in the art to which this specification pertains to easily carry out the embodiments. Furthermore, in order to clearly describe the present disclosure, parts not related to the description may be omitted in the drawings.

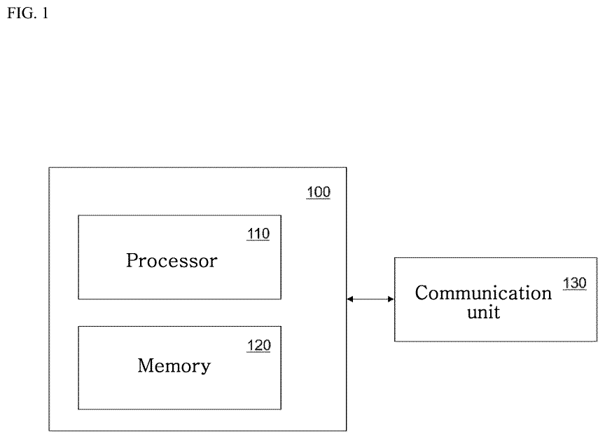

FIG. 1 is a diagram illustrating a server or a client related to this specification.

In this specification, the server (or a cloud server) or the client may include a controller 100 and a communication unit 130. The controller 100 may include a processor 110 and a memory 120. The processor 110 may perform instructions stored in the memory 120. The processor 110 may control the communication unit 130. 10 The processor 110 may control an operation of the

server or the client based on an instruction that is stored in the memory 120. The server or the client may include one processor, or may include a plurality of processors. If the server or the client includes a plurality of processors, at least some of the plurality of processors may be disposed at places that are physically spaced apart from each other. Furthermore, the server or the client is not limited thereto, and may be implemented by using various known methods.

The communication unit 130 may include one or more modules that enable wireless communication between the server or the client and a wireless communication system, between the server or the client and another server or client, or between the server or the client and an external server. Furthermore, the communication unit 110 may include one or more modules that connect the server or the client to one or more networks.

The controller 100 may control at least some of the elements of the server or the client in order to drive an application program that is stored in the memory 120.

Moreover, the controller 100 may combine and drive at least two of the elements that are included in the server or the client in order to drive the application program.

In this specification, the server may include a reversing engine or/and a contents disarm and reconstruction (CDR) engine that provides CDR services.

### Reversing Engine

A reversing engine is an analysis/diagnosis engine obtained by automating a reverse engineering (reversing) process for a malicious non-PE file.

For example, the reversing engine may perform the following steps.
1. File analysis: this is a step of analyzing an appearance (e.g., properties, an author, a date created, or a file type) of a non-PE file itself. In this step, whether a non-PE file is malicious may be diagnosed based on only information of the non-PE file itself like a common vaccine program.
2. Static analysis: this is a step of determining whether a non-PE file is normal or malicious by extracting and analyzing data within the non-PE file. In this step, whether a non-PE file is malicious may be diagnosed by extracting internal data suitably for a file structure and comparing and analyzing the extracted data, without executing the non-PE file. This step may be suitable for a macro, the extraction and analysis of a URL, etc.
3. Dynamic analysis: this is a step of determining whether a non-PE file is malicious by analyzing an act of the non-PE file while executing and monitoring the non-PE file. If this step is used, a malicious act using a normal function, such as a macro, a hyperlink, or DDE, can be easily detected.
4. Debugging analysis: this is a step of analyzing vulnerability, exploits, etc. by executing and debugging a non-PE file. This step is suitable for detecting the vulnerability of an application program using a body, a table, a font, a picture, etc. within a document, including a macro, a hyperlink, or DDE.

The reversing engine may include a debugging engine which may be used in debugging analysis. The debugging engine can diagnose vulnerability which occurs in a document input, processing, and output stage by debugging a process of reading a non-PE file. In this case, the vulnerability refer to an error, a bug or the like, which occurs when an application program receives an unexpected value in a code (or logic) developed by a developer of the application program. An attacker may execute a malicious act, such as the denial of service attributable to abnormal termination or the remote execution of a code, through the vulnerability.

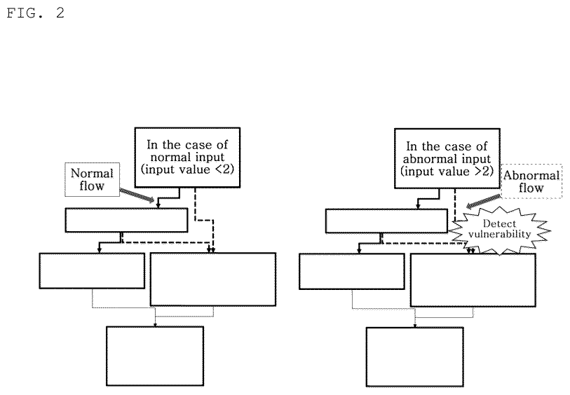

FIG. 2 is an example of an abnormal input which may be applied to this specification.

Referring to FIG. 2, when receiving an abnormal value (e.g., when an input value is greater than 2, that is, a normal range) through a non-PE file, an execution flow of an application program changes into an execution flow not intended by a developer, so that vulnerability may occur. The debugging engine may set a break point at a specific point that is related to the vulnerability by automatically debugging a document reading process, may check the specific value related to the input value, and may diagnose whether the non-PE file is malicious by determining whether the input value is a value that causes the vulnerability.

More specifically, the debugging engine may start debugging by checking the non-PE file and executing the application program for reading the non-PE file. When a module is loaded in the process of reading the non-PE file, the debugging engine may check whether the corresponding module is an analysis target module, and may set the break point at a designated address when the corresponding module is an analysis target.

For example, a malicious non-PE file may have branch points at which an application program is terminated or a flow of the application program branches into a flow in which any malicious act does not occur when a version of the application program or a specific condition, such as an operating system environment, is not satisfied. The server may set a break point at a branch point that is previously analyzed by an analyst and that has such a possibility.

Furthermore, the server may set conditions on which the server may continue to execute the application program without terminating the application program or may induce a flow of the application program into a flow in which a malicious act may occur, in association with a corresponding branch point.

If a process of the application program is stopped at a corresponding break point during the process, the server may perform a step of detecting the occurrence of vulnerability through detection logic and then storing the results of the detection in an analysis report.

The automation reversing engine that is included in the server can diagnose and block a malicious non-PE file through a diagnosis algorithm researched and developed by an analyst, by analyzing the aforementioned steps while automatically performing the aforementioned steps.

### Contents Disarm and Reconstruction (CDR)

A CDR service is a solution that generates a new file by decomposing a non-PE file, removing a malicious file or an unnecessary file from the non-PE file, and making content therein identical with the original as much as possible.

That is, CDR means a service that generates a safe document by disarming and reconstructing content within a document and that provides the safe document to a customer. A disarming target file may include all non-PE files (e.g., a MS Word, Excel, PowerPoint, a Hangul, and a PDF). Disarming target content may be active content (e.g., a macro, a hyperlink, and an OLE object).

Hereinafter, in an MS Excel document format, MS-OOXML SpreadsheetML and MS-XLS are exemplified, but the present disclosure is not limited thereto. The present disclosure may be similarly applied to another MS Excel document format. Furthermore, file names that are exemplified below may be changed into suitable file names, if necessary.

SpreadsheetML is an XML schema for Microsoft Office Excel.

### Structure of MS-OOXML SpreadsheetML

Table 1 exemplifies a file structure which includes an element related to DDE included in MS-OOXML SpreadsheetML.

TABLE 1

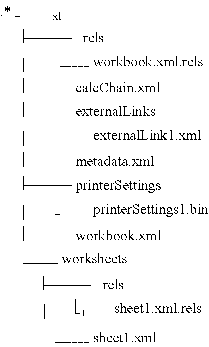

Table 1 exemplifies a file structure that is newly generated or changed when if DDE is added to an XLSX document. The XLSX document may include [Content_Types].xml, workbook.xml, [.rels], and externalLink1.xml. The aforementioned files are classified based on information included therein and purposes thereof, and the present disclosure is not limited to corresponding file names.
Reference: ECMA-376 5th edition 2016 Ecma Office Open XML Part 1—Fundamentals And Markup Language Reference.pdf

### 1) [Content Types].xml

Table 2 exemplifies a construction of [Content_Types].xml.

TABLE 2

<<Types ...>
<Override
PartName=“/xl/externalLinks/externalLink1.xml”
ContentType=“application/vnd.openxmlformats-
officedocument.spreadsheetml.externalLink+xml”/>
</Types>

Information related to DDE is included in externalLink1.xml. Referring to Table 2, PartName, that is, location information of externalLink1.xml, and ContentType, that is, structure information of externalLink1.xml, may be registered with [Content Types].xml.

The server may identify that an external link is present based on ContentType.

2) workbook.xml [.rel]
(1) workbook.xml

Table 3 exemplifies a construction of workbook.xml.

TABLE 3

```
<workbook ...>
  <externalReferences>
    <externalReference r:id=“rId2”/>
  </externalReferences>
</workbook>
```

(2) workbook.xml.rel

Table 4 exemplifies a construction of workbook.xml.rel.

TABLE 4

```
<Relationships ...>
  <Relationship
    Id=“rId2” Target=“externalLinks/externalLink1.xml”
Type=“http://schemas.openxmlformats.org/officeDocument/2006
/relationships/externalLink”>
</Relationships>
```

3) externalLink1.xml

Table 5 exemplifies a construction of externalLink1.xml.

```
TABLE 5
<externalLink...>
  <ddeLink xmlns:r=“...” ddeService=“cmd” ddeTopic=“/C
calc”>
      <ddeItems>
        <ddeItem name=“A0” advise=“1”/>
        <ddeItem name=“StdDocumentName” ole=“1” advise=“1”/>
      </ddeItems>
    </ddeLink>
  </externalLink>
```

Referring to Table 5, the specification of ddelink is as follows.

18.14.4 ddeLink (DDE Connection)

A ddeLink element indicates a connection to an external DDE server. DDE is a method of transmitting data between application programs by using a Windows message according to a protocol that has been stably documented since about 1990.

A hierarchical structure of a name that is defined by the DDE server is Application, Topic, and an item. Topic frequently corresponds to a unit, such as a file, a document, or a database name. The item indicates a subset of data, such as a cell range, a row, a field, or a column. DDE items may have several values.
ddeService (Service name): a service name (i.e., an application name) for a DDE connection.
ddeTopic (Topic for DDE server): this describes a DDE application program to which a channel is related (usually a document of that application).

More specifically, it may be seen that ddeService plays a role as an execution instruction and ddeTopic plays a role as a factor for such an instruction. Removing “xml” not analyzed in this specification, including ddeLink, causes enormous complexity. Furthermore, there is a problem in that proper reconstruction of an MS Excel document is not guaranteed.

For example, if the following DDE is given:

=MSExcel|‘\..\..\..\Windows\System32\cmd.exe /c calc.exe‘!’’

MSExcel may be registered with ddeService, and \..\..\..\Windows\System32\cmd.exe /c calc.exe may be registered with ddeTopic. This means that ddeService cannot be specified by only “cmd.”

Accordingly, in this specification, if the string of ddeService and ddeTopic includes “cmd” as a word, the server may replace an attribute value of ddeService and ddeTopic with “_” (low line) by a string length that was previously preset as an attribute value.

The reason for this is that thoughtlessly removing a DDE function is dangerous because the DDE function itself refers to other data (e.g., Excel or a database).

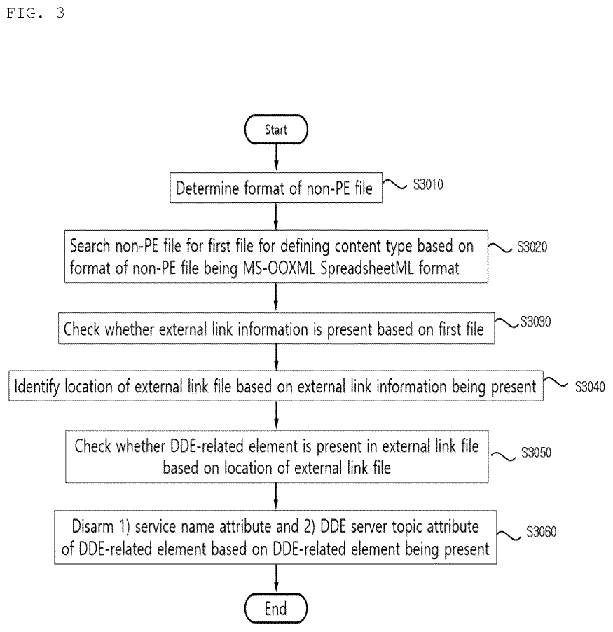

FIG. 3 exemplifies a method of disarming DDE in MS-OOXML SpreadsheetML to which this specification may be applied.

Referring to FIG. 3, the server determines a format of a non-PE file (S3010).

For example, the server may identify a multipurpose Internet mail extensions (MIME) type of the non-PE file in order to determine whether the non-PE file has an MS-OOXML SpreadsheetML format. The MIME type may indicate a characteristic and format of a document, a file, or a byte vowel. The MIME type has been defined and standardized in RFC 6838.2022.4.30 of IETF.

The server searches the non-PE file for a first file for defining a content type, based on the format of the non-PE file being the MS-OOXML SpreadsheetML format (S3020). For example, the server may search a file included in the non-PE file for [Content_Types].xml (the first file).

The server checks whether external link information is present based on the first file (S3030). For example, the server may identify whether ContentType within an Override element in [Content_Types].xml is “application/vnd.openxmlformats-officedocument.spreadsheetml.externalLink+xml”.

The server identifies a location of an external link file related to DDE, based on the external link information being present (S3040). For example, the external link file may be externalLink1.xml. The server may identify a location of an xml file related to the external link in PartName of [Content_Types].xml.

The server checks whether a DDE-related element is present in the external link file based on the location of the external link file (S3050). For example, the server may check whether a ddeLink element is present in externalLink1.xml.

The server disarms 1) a service name attribute and 2) DDE server topic attribute of the DDE-related element based on the DDE-related element being present (S3060). For example, the service name attribute may be a ddeService attribute, and the DDE server topic attribute may be a ddeTopic attribute. If a command sentence “cmd” is included in the string of the ddeService attribute or ddeTopic attribute, the server may replace the existing string with “_” (low line, 0x5F) by inserting “_” (low line, 0x5F) by a string length that was present in the ddeService attribute and the ddeTopic attribute. If the existing string is simply removed or replaced with a blank, it may be determined that a corresponding non-PE file has been broken. Accordingly, the server replaces the existing string with “_” (low line, 0x5F).

### Structure of XLS Format

Table 6 is an example of an item which may be added as DDE in a document having the XLS format.

TABLE 6

=cmd|‘/C calc’!A0
+cmd|‘/C calc’!A0
−cmd|‘/C calc’!A0
@SUM(A1:A2)*cmd|‘/C calc’!A0

The following examples are not limited to specific file names.

Table 7 exemplifies a file structure which includes an element related to DDE included in a document having the XLS format.

TABLE 7

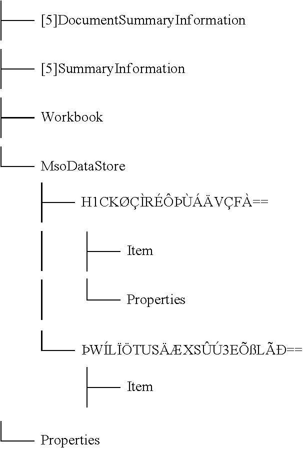

Table 7 exemplifies a file structure which may be obtained by releasing the document having the XLS format in Table 6.

Formal titles which are used in a compound binary file (CFB) including the XLS format are as follows.
storage: in general, the storage is the same as a name called a folder or a directory.
stream: the stream is the same as an entry when compared to a compressed file as a word corresponding to a file.

A CFB specification is shared through a web.
Reference: [MS-XLS]: Excel Binary File Format (.xls) Structure, https://docs/microsoft.com/en-us/openspecs/office_file_formats/ms-zls/cd03cb5f-ca02-4934-a391-bb674cb8aa06

Workbook Stream includes Globals Substream. The following is a specification related to DDE in a structure within Globals Substream.

### 2.1.7.20.3 Globals Substream

WORKBOOKCONTENT=[WriteProtect][FilePass][Template]INTERFACE WriteAccess [FileSharing]CodePage*2047Lel DSF[Excel9File]RRTabId [ObProj][ObNoMacros][CodeName][FNGROUPS]*Lbl[OleObjectSize]PROTECTION1*Window1Backup HideObj Date1904 CalcPrecision RefreshAll BookBool FORMATTING*(PIVOTCACHEDEFINITION)[DOCROUTE]*UserBView UsesELFs 1*BUNDLESHEET METADATA [MTRSettings][ForceFullCalculation]Country*SUPBOOK*LBL*RTD[RecalcId]*HFPicture*MSODRAWINGGROUP[SHAREDSTRINGS]ExtSST*WebPub[WOpt][CrErr][BookExt]*FeatHdr*DConn[THEME][CompressPictures][Compat12][GUIDTypeLib] EOF

WORKBOOK=BOF WORKBOOKCONTENT

SUPBOOK=SupBook [*ExternName*(XCT*CRN)][ExternSheet]*Continue

A record related to DDE in the sequence of the Globals Substream specification is SUPBOOK.

Since the structure of Globals Substream is not nested, the server may target SUPBOOK even without checking the entire structure of Globals Substream by specifying SUPBOOK.

### 2) SupBook

The specification of SupBook is as follows.

### 2.4.271 SupBook

A SupBook record designates a supporting link related to DDE, and specifies the start of a record vowel that is defined by a Globals Substream augmented Backus-Naur form (ABNF).

The record vowel may designate the contents of an external workbook, a DDE data source, or an object linking and embedding (OLE) data source.

ctab (2 bytes):

An undefined field that designates the number of sheets in a referred external workbook, a reserved field, or an unsigned integer.
The type of supporting link designated in cch and virtPath: DDE data source referencing
Meaning: MUST be 0x0000.

cch (2 bytes):

An unsigned integer that designates a supporting link type or designates a string length of virtPath.
0x0001 to 0x00ff (inclusive)

virtPath(VirtualPath) (variable):

The type of supporting link related to DDE and an XLUnicodeStringNoCch structure that designates a target (if the target corresponds to the type of supporting link) of the corresponding supporting link.

XLUnicodeStringNoCch

The specification of XLUnicodeStringNoCch is as follows.

### 2.5.296 XLUnicodeStringNoCch

The structure of XLUnicodeStringNoCch designates a unicode string. If XLUnicodeStringNoCch is used, the number of characters of a string needs to be designated in a structure using XLUnicodeStringNoCch.

A—fHighByte (1 bit):

A bit that designates whether characters of rgb are double-byte characters.

The bit follows values of the following table:
0x00: All the characters in the string have a high byte of 0x00 and only the low bytes are in rgb.
0x01: All the characters in the string are saved as double-byte characters in rgb.

reserved (7 bits):

This has a value 0 and needs to be neglected.

rgb (variable):

This is an array of bytes that designate a string.

If fHighByte is 0x0, the size of the array needs to be equal to the number of characters of the string.

If fHighByte is 0x1, the size of the array needs to be equal to twice the number of characters of the string.

Referring to the aforementioned specification, the server may access rgb data based on fHighByte.

VirtualPath

The specification of VirtualPath is as follows.

### 2.5.277 VirtualPath

This needs to be a string that follows the following grammar:

virt-path=volume/unc-volume/rel-volume/transfer-protocol/

startup/alt-startup/library/simple-file-path/ole-link

ole-link=path-string %x0003 path-string

simple-file-path=[%x0001]file-path

startup=%x0001%x0006 file-path

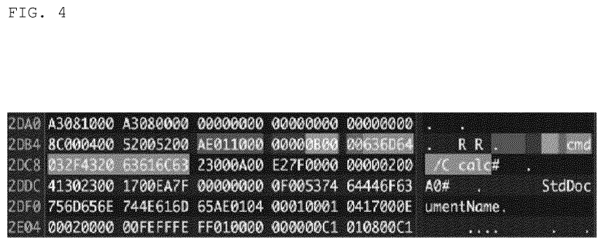

FIG. 4 exemplifies binary codes of SupBook to which this specification may be applied.

Binary codes from “AE011000” to “63616C63” are sequentially described below with reference to FIG. 4.

“AE011000” may be a record type and a record area indicative of a record size.

“0000” may indicate ctab.

“0B00” may indicate cch.

“00636D64 032F4320 63616C63” may indicate virPath. virPath may have an XLUnicodeStringNoCch structure. More specifically, in the XLUnicodeStringNoCch structure, the highest rank “00” includes fHighByte and reserved, and “636D64 032F4320 63616C63” may indicate rgb.

The aforementioned “rgb” is more specifically exemplified as follows:
[63 6D 64 03 2F 43 20 63 61 6C 63]→“cmd \x03 /C calc”

This is the same as the ole-link in the aforementioned specification. FIG. 4 may be indicated like Table 6 in Excel. A front part “path-string” and rear part “path-string” of the ole-link may be generalized as follows, assuming that the front part “path-string” is ps1 and the rear part “path-string” is ps2:

Grammar: ps1 %x0003 ps2

Excel: ps1|ps2

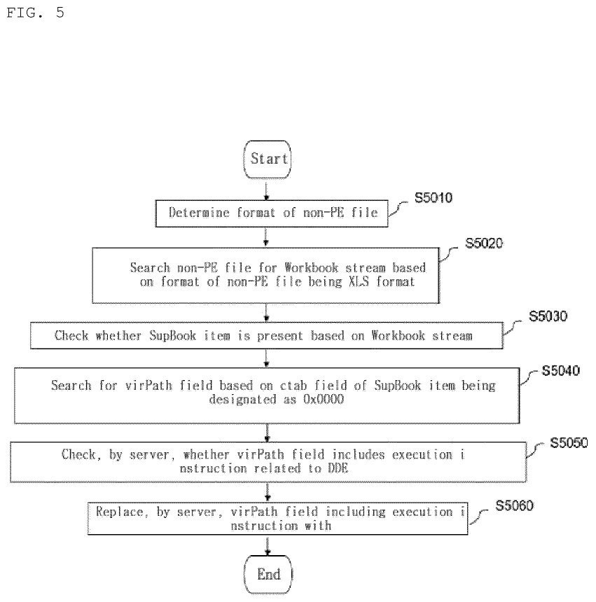

FIG. 5 exemplifies a method of disarming DDE in an XLS format to which this specification may be applied.

Referring to FIG. 5, the server determines a format of a non-PE file (S5010).

For example, the server may identify an MIME type of the non-PE file in order to determine whether the non-PE file has the XLS format.

The server searches the non-PE file for a Workbook stream based on the format of the non-PE file being the XLS format (S5020). For example, the server may search a file included in the non-PE file for the Workbook stream.

The server checks whether a SupBook item is present based on the Workbook stream (S5030). For example, the server may search whether the SupBook item is present in content of the Workbook stream.

The server searches for a virPath field based on the ctab field of the SupBook item being designated as 0x0000 (S5040). The server checks whether the virPath field

includes an execution instruction related to DDE (S5050). For example, the server may check whether rgb of the virPath field includes the execution instruction.

The server disarms the virPath field including the execution instruction (S5060). For example, if a command sentence “cmd” is included in the virPath field, the server may replace the existing virPath field with “_” (low line, 0x5F) by inserting “_” (low line, 0x5F) by the length of the virPath field. If the existing virPath field is simply removed or replaced with or a blank, it may be determined that a corresponding non-PE file has been broken. Accordingly, the server replaces the existing virPath field with “_” (low line, 0x5F).

When the operation of checking or searching for in FIGS. 3 and 5 fails, the server may terminate the disarming operation because the server may determine that a disarming target is not present in a corresponding non-PE document.

The aforementioned present disclosure may be implemented in a medium on which a program has been recorded as a computer-readable code. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, a magnetic tape, a floppy disk, an optical data storage device, and also include an implementation having the form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the elements described in the embodiments may be modified and implemented. Furthermore, differences related to such modifications and applications should be construed as belonging to the scope of the present disclosure defined in the appended claims.

1. A method of disarming, by a server, dynamic data exchange (DDE) in a non-portable executable (non-PE) file, the method comprising:
determining a format of the non-PE file;
searching the non-PE file for a first file for defining a content type based on the format of the non-PE file being an MS-OOXML SpreadsheetML format;
checking whether external link information related to the DDE is present based on the first file;
identifying a location of an external link file based on the external link information being present;
checking whether a DDE-related element is present in the external link file based on the location of the external link file; and
disarming 1) a service name attribute and 2) DDE server topic attribute of the DDE-related element.

2. The method of claim 1, wherein the first file is a [Content_Types].xml file.

3. The method of claim 2, wherein the checking of whether the external link information is present is based on a content type within an element of the first file.

4. The method of claim 3, wherein the external link file is an externalLink1.xml file.

5. The method of claim 4, wherein:
the service name attribute is a ddeService attribute, and
the DDE server topic attribute is a ddeTopic attribute.

6. The method of claim 1, further comprising:
searching for a Workbook stream based on the format of the non-PE file being an XLS format;
checking whether a SupBook item is present based on the Workbook stream;
searching for a virPath field based on a ctab field of the SupBook item being designated as 0x0000;
checking whether the virPath field comprises an execution instruction related to the DDE; and
disarming a virPath field comprising the execution instruction.

7. The method of claim 6, wherein the disarming of the virPath field comprises replacing the virPath field with “_”

38. A server which disarms dynamic data exchange (DDE) in a non-portable executable (non-PE) file, the server comprising:
a communication unit;
a memory comprising a contents disarm and reconstruction (CDR) engine for performing the disarming; and
a processor configured to functionally control the communication unit and the memory,
wherein the processor is configured to determine a format of the non-PE file, search the non-PE file for a first file for defining a content type based on the format of the non-PE file being an MS-OOXML SpreadsheetML format, check whether external link information related to the DDE is present based on the first file, identify a location of an external link file based on the external link information being present, check whether a DDE-related element is present in the external link file based on the location of the external link file, and disarm 1) a service name attribute and 2) DDE server topic attribute of the DDE-related element.
